(19) United States
(12) Patent Application Publication
(10) Pub. No.: US 2022/0304880 A1
(43) Pub. Date: Sep. 29, 2022

(54) MEDICAL PROCEDURE FACILITATION SYSTEM

(71) Applicants: William Beaumont Hospital, Royal Oak, MI (US); GRAND VALLEY STATE UNIVERSITY, Allendale, MI (US)

(72) Inventors: Marlene SELTZER, Royal Oak, MI (US); Robert A. LONG, Lansing, MI (US); John FARRIS, Grand Rapids, MI (US); Roy VISSER, Coopersville, MI (US)

(21) Appl. No.: 17/718,240

(22) Filed: Apr. 11, 2022

Related U.S. Application Data
(63) Continuation-in-part of application No. 17/575,426, filed on Jan. 13, 2022.
(60) Provisional application No. 63/142,686, filed on Jan. 28, 2021.

(51) Int. Cl. A61G 13/12; A61G 13/00

(52) U.S. Cl. CPC A61G 13/1245; A61G 13/0009; A61G 13/009

(57) ABSTRACT

A medical procedure facilitation system for use with an operating platform. The medical procedure facilitation system has a pair of assisting arms and lifting arms secured to the operating platform that may swing along a path of rotation. A chain and sprocket mechanism connects the lower end regions of the assisting and lifting arms for communicating a lifting force from the patient to supporting thigh pads that raise a patient's legs.

### REFERENCE TO RELATED APPLICATIONS

This application is a continuation-in-part of U.S. Ser. No. 17/575,426, filed on Jan. 13, 2022, which claims the benefit of U.S. provisional application Ser. No. 63/142,686 filed Jan. 28, 2021, the disclosures of which are hereby incorporated in their entirety by reference herein.

### TECHNICAL FIELD

One aspect of this disclosure involves a medical procedure facilitation system. One non-limiting example is childbirth. The system provides an adjustable thigh-lifting and positioning force for patients and staff while raising a patient's legs in the childbirth procedure. That force is provided by an assisting arm that is engaged by the patient's hands. In other clinical settings, the system may be usefully deployed in, for instance, gynecological examinations and pelvic exams for female and male patients, to reduce the stress experienced during leg raising.

### BACKGROUND

Medical procedures are many and varied. In the birthing process, for example, Stage 2 is known as the pushing phase. Laboring mothers typically assume a lithotomy position with intermittent hip flexion and execute a Valsalva maneuver to create the expulsive forces necessary to deliver the baby. In this environment, it would be desirable to provide a labor-assist system to help the mother to get into and maintain the lithotomy position during contractions.

In one exemplary environment of use, the most common method of giving birth in a hospital setting involves the patient lying on her back and lifting her knees toward her shoulders. For obese women, especially those with epidurals, this process is especially difficult as they often have trouble bearing the weight of each leg or reaching underneath their thighs to grip behind the knee. The patient is often assisted by a family member or a medical professional who tries to hold the leg in the correct position. This puts the women at risk of injury, gives the potential for injury to the assistant based on repetitive lifting, and limits the ability of medical professionals to work efficiently. There are no current solutions available to assist obese patients that mimic the natural posture most needed during this process.

The need for labor assist systems is acutely felt in the case of overweight and obese patients.

In 2019, there were approximately 3.7 million births in the United States, ⅔ of which were delivered vaginally. Labor is characterized by three successive stages—Stage 2 is defined as the pushing phase. A laboring mother typically uses the lithotomy position with intermittent hip flexion and Valsalva to create the expulsive forces necessary to deliver the fetus. This action is repeated with each contraction approximately every three minutes for up to 4 hours. Most laboring mothers utilize epidural analgesia and require the assistance of a healthcare provider or family member to lift and support the legs and thighs. Given the prevalence of obesity and duration of this repetitive lifting, loss of patient autonomy and caregiver injury are significant issues. It has been reported that 8 out of 10 labor and delivery nurses report musculoskeletal pain.

Against this background, it would be desirable to provide a labor assist device that helps restore a laboring mother's independence and lessen the burden for healthcare providers when women labor in the lithotomy position.

Suitable labor assist systems are of interest to medical professionals working in prenatal care, gynecology, or obstetrics who are responsible for the well-being of their patients and the success of a delivery.

There are delivery beds with built-in leg supports that adjust in height in this field. These can be tuned to fit the patient, but are not controlled by the patient and may not lift their legs into the optimal pushing position.

Substitute labor assist products include fabric straps and BirthBuddy. Though not a labor assist system, YelloFin stirrups attach to any operating room table. They allow the movement of a patient's legs over a range of abduction and flexion with the help of a linear actuator. YelloFin stirrups are not designed to be adjusted by the patient, but by the surgeon. Fabric straps are looped on each leg and the patient's foot goes through one loop. The patient holds the other loop and pulls on the straps to bring her knees back, with more leverage than she would have to pull from under her knees. BirthBuddy provides the rowing pull motion that increases pushing efficacy, but its positioning in front of a bed can restrict the work area of the nurses and doctors.

Products currently on the market do not provide any patient-controlled assisting force, or limits on flexion and abduction to prevent injury. They also lack effective attachment to current hospital beds without interfering with the doctor's access to the patient. Thus, a need has arisen for a labor assist system that surpasses the current products and offers a novel solution.

### SUMMARY

Throughout this disclosure non-limiting references are made to gender. It will be appreciated that depending on the medical procedure, the use of male/female and his/her should not be construed as limiting the structure or field of use of the system.

Disclosed is a medical procedure facilitation system for use with an operating platform such as a bed, surgical table, or mattress or upon which the patient is recumbent, semi-recumbent, or in a semi-Fowler position. For reference, the bed has lateral edges to which a pair of assisting arms are secured. Those arms are grasped by the patient, who can exert an assisting force. The arms are adapted to move in a vertical plane that lies parallel to the lateral edges along a path of rotation. Hand grips are mounted on the assisting arms that allow the patient to contribute to lifting forces.

Also secured to the lateral edges proximate a foot-end side of the assisting arms is a pair of lifting arms. Those arms are also adapted to move in a vertical plane that lies parallel to the lateral edges along a path of rotation. Extending from the lifting arms are thigh pads that underlie a patient's thighs.

To communicate a patient-provided assisting force to the lifting arms, a chain and sprocket mechanism are provided. That mechanism extends between the lower end regions of the pairs of assisting arms and the pairs of lifting arms. The chain and sprocket mechanism delivers an adjustable force that assists in raising and securing one or more positions of the patient's legs.

An optional integrated locking mechanism allows the medical staff or patient to lock the framework in place at any position so that the patient can have her legs entirely supported by the system.

Users of such systems include women in labor or men undergoing for example a pelvic or other examination or other operations, and nurses or other assistants who may modify the settings of the system and help the patient.

### BRIEF DESCRIPTION OF THE DRAWINGS

FIG. 1 is a front quartering perspective view of a medical procedure facilitation system secured to an operating platform, such as a bed;

FIG. 2 is a front quartering perspective view of the system when separated from the operating platform;

FIG. 3 is a rear quartering perspective view of the system when separated from the operating platform;

FIG. 4 illustrates a chain and sprocket mechanism that links the lower end regions of an assisting arm (driving member) and a lifting arm (driven member);

FIG. 5 is a side view of a ratchet and pawl mechanism;

FIG. 6 is a rear right perspective view thereof.

FIG. 7 is a rear left exploded view thereof.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

An improved design of a medical procedure facilitation system has some features that are in common with a previous design disclosed in the parent application. Before turning to the improved design, some aspects of embodiments disclosed in the parent application will first be outlined.

### FEATURES DISCLOSED IN THE PARENT APPLICATION

One embodiment of an earlier design includes two thigh-lifting arms that are fitted to the sides of a labor and delivery bed. A thigh pad is attached to each arm. The position of each pad can be moved perpendicular and parallel to the arm to accommodate women of different sizes. In addition, the pad can rotate about two axes. The first axis is perpendicular to the face of the pad and the second axis is perpendicular to the arm. During a contraction, adjustable handles at the top of each arm allow the patient to pull on the arms to assist her in assuming the lithotomy position.

The parent application disclosed several embodiments of the labor assist system which provide force to alleviate patient strain. The system is coupled to a hospital bed. In one example, the arms of the system are mounted parallel to the sides of the bed. One arm is on the left side and one arm is on the right side. In one case, two arms are secured to a mounting plate which then couples to the hospital labor bed. In one embodiment, the arms rotate from the plane of the bedplate from a parallel position to a position up to approximately 80-85 degrees above parallel.

Crossbars are fixed to the arms of the system at 90 degrees pointing into and parallel to the bed. Leg pads or thigh pad plates 4 are fixed to the crossbars of the system and are positioned on the backside of the patient's thigh directly under the knee. The leg pads are free to rotate to adjust the patient's posture and leg's desired position.

The main arms of the system are formed by telescoping tubing that allows the system to be adjusted based on the dimensions and parameters of the patient. The system has adjustable handgrips or handles located on the arm and on the inside of the leg pad for the patient to grasp while pulling her legs.

One embodiment has independent sides. This allows the patient to move each leg independently. There are many advantages to this option based on the patient and different techniques and positioning (such as the OP position) for child labor. The first option would be independent, and the second would be to have the sides connected and move together.

It will be appreciated that the use of the assisting force technology design for female patients during child and other clinical procedures could benefit male patients during pelvic area procedures and operations.

As noted earlier, the system disclosed in the parent application offered some opportunities for improvement. Accordingly, this disclosure now turns to systems that are embodied in an improved design.

Subsystems Embodied in an Improved Design

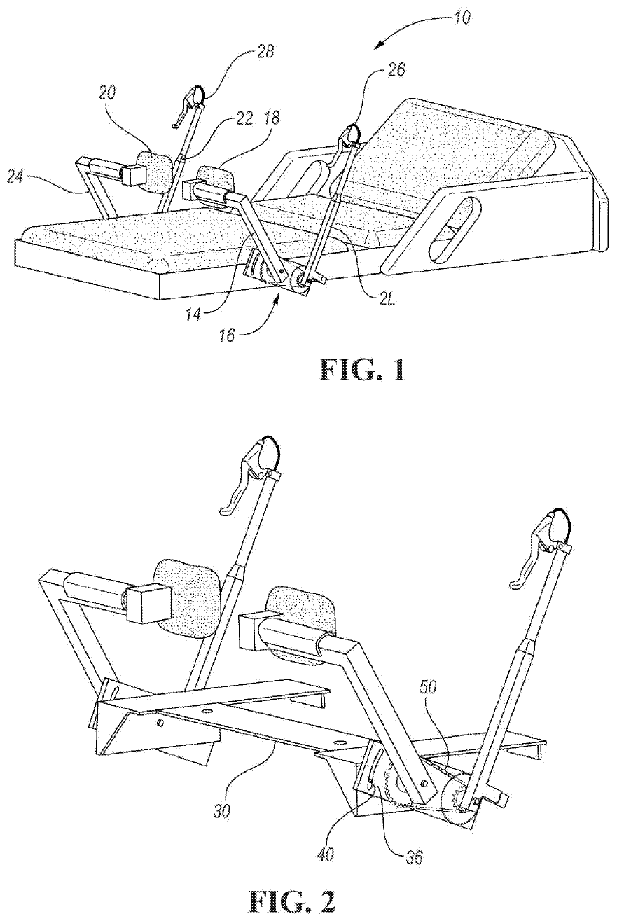

Turning first to FIGS. 1-3, one embodiment of an improved system design of a medical procedure facilitation device 10 has driving (assisting) arms 12, 22 and driven (lifting) arms 14, 24 on each side of the bed that use associated chain and sprocket mechanisms 16 to communicate forces from the patient's arms to the patient's legs, thereby providing thigh-lifting assistance.

In a preferred embodiment, the assisting arms 12, 22 may move independently of each other, i.e., they are de-coupled. Similarly for the lifting arms 14, 24.

Each thigh pad 18,20 is attached to the end of an associated lifting arm 14, 24. Each thigh pad 18 and 22 goes under the patient's thigh just above her knee. The mother grasps the handgrip 26, 28 of an associated assisting arm 12, 22 and pulls. The chain and sprocket mechanism 16 (one on each side of the bed) connects an assisting arm 12 to the associated lifting arm 14. The arms 12, 22 augment the patient's input force, thereby helping to lift her thighs.

The thigh pads 18 and 20 are respectively connected to the lifting arms 14, 24. The handles 26, 28 for the patient to grasp are positioned proximate to the upper ends of the assisting arms 12, 22. The sprocket and chain mechanism 16 is deployed at the lower ends of the assisting and lifting arms.

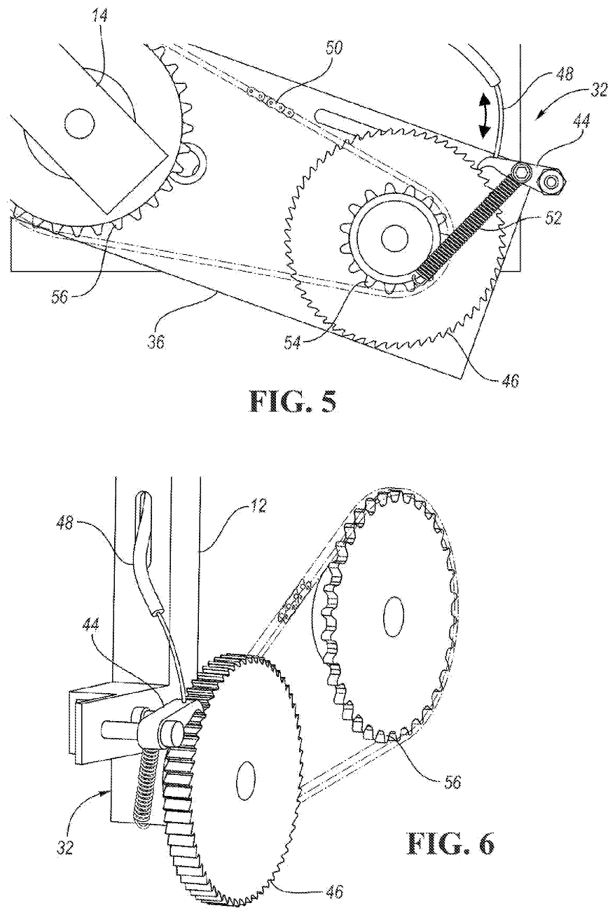

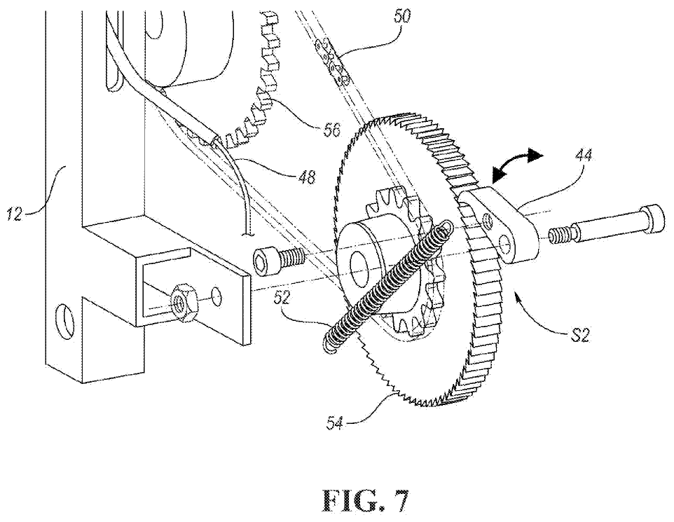

It will be appreciated that drive mechanisms other than a chain and sprocket arrangement may perform satisfactorily. FIGS. 5-7 suggest a belt 50 that engages the assisting arm sprocket 52 and the lifting arm sprocket 54. Alternative examples include a belt and pulley (preferably, non-slip) arrangement and a hybrid approach, wherein the grooves of a pulley house teeth that engage an overlying belt with or with recesses that receive the teeth. Other alternative examples include beltless gearing arrangements.

Preferably, a bedplate 30 (FIG. 2) connects the respective assisting arms 12, 22 two sets of arms 100, 102 on each side, and in one embodiment is secured to the operating platform, such as a bed underneath the mattress or an operating table.

A side view of a representative chain and sprocket embodiment appears in FIG. 4. The chain and sprocket mechanism 16 provides a mechanical advantage to the patient. For every pound of force that the patient exerts by pulling back on the handles 26, 28 of the assisting arms 12, 22 a larger force is exerted by the thigh pads 18, 20 extending from the lifting arms 14, 24 to her thighs. Therefore, the device assists the patient in assuming and maintaining the lithotomy position during contractions. At the end of the contraction, the patient lowers the handles 12, 22 and her legs return to the resting position.

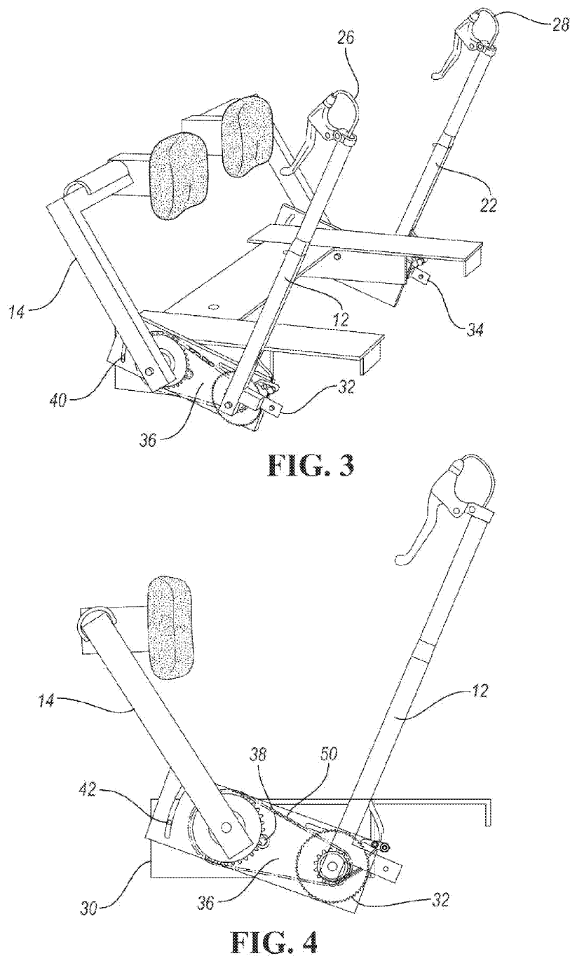

A ratchet and pawl mechanism 32 (FIGS. 3-7) is attached to a lower end region of each assisting arm 12, 22. The ratchet and pawl mechanism (one on each side of the operating platform) is linked to the patient's handgrip 28. Each handgrip 28 has an associated lever that holds a pawl 44 away from the ratchet 46 when the patient grasps the lever and pulls it toward the handgrip 28. If the lever is not depressed, then the ratchet 46 is engaged with the pawl 44 under the influence of a spring 52. This prevents the upper-end region of the assisting arm 12 from moving away from the patient. When the ratchet 46 is engaged with the pawl 44, the lifting arm 14 is also prevented from rotating and allowing the patient's thighs to lower.

The pawl 44 is held in the default position, engaged with the ratchet 46, with the spring 52. The ratchet and pawl system prevents the lifting arm 14, 24 that supports the thighs of the patient from swinging down and possibly hitting a caregiver if the patient suddenly releases the handgrip 28.

Thus, each ratchet and pawl mechanism 32 (one on each side of the operating platform) ensures that the associated assisting arms 12, 22 and lifting arms 14, 24 respectively can only move when the patient squeezes the associated lever 26, 28. A rod or cable 48 connects a grasping handle 26, 28 to an associated spring-loaded pawl 32, 34 that normally lies in a seated (engaged) position. Each ratchet 46 may share an axle with an assisting arm 12, and 22 and engage a respective pawl 44.

Each ratchet 44 preferably is spring-biased. Its rotation is impeded by an associated pawl 46. The pawl 44 is engaged when the gripping handle 28 is released, i.e., not squeezed. When a pulling force is exerted by the patient, the ratchet 46 rides over the pawl 44, thereby permitting movement of the associated assisting and lifting arms 12, 14. Upon force release, engagement of the pawls 44 and ratchets 46 occurs and the system reverts to a locked state. The ratchet and pawl mechanism 32 thus allows the patient to lock the medical procedure facilitation (e.g., labor assist) device 10 in any position. For instance, the patient may want to lock the system during a contraction when she is in the lithotomy position.

In addition, the ratchet and pawl mechanism 32 on each side of the operating platform and associated handles 26, 28 ensure that the lifting arms 14, 24 will not fall if the patient unexpectedly releases either handle 26, 28. This feature protects both the patient and the medical professionals rendering care.

The lower end regions of the arms 12, 22, 14, 24, sprockets 16 on each side of the operating platform and ratchet 32 on each side of the operating platform are mounted on plates 36 (one per side) (FIGS. 2-4) that can rotate in the vertical plane relative to the operating platform. Each plate 36 rotates about a stationary bolt 38 that secures the mounting plate 36 to the operating platform. The mounting plate 36 has slot 40 which receives a stud 42 to limit rotation of the mounting plate 36. This swiveling feature of the mounting plate 36 allows the medical procedure facilitation system 10 to be adjusted to accommodate patients of different sizes.

Other features allow the labor assist device to accommodate patients of different sizes. In one embodiment, an extendable assisting arm 12, 22 is provided. In another embodiment, a mechanism is provided that allows the thigh pads 18, 20 to move perpendicularly to the centerline of the operating platform.

The labor assist device embodiment in particular not only improves the patient's experience but also reduces the need for medical professionals to assist the patient in lifting her legs. Often caregivers must assist repetitively from positions that put them at risk for sustaining musculoskeletal injuries. In situations where the patient requires additional help, caregivers will be able to apply supplements to the assisting force, thereby safely elevating or positioning the lifting arms 14, 24 to achieve the desired pushing position.

To recap, in one embodiment of the disclosed medical procedure facilitation system 10, a labor assist system can be used by both the laboring mother and the caregiver. The labor assist system utilizes a patient-controlled mechanical advantage to safely support and assist in lifting the lower extremities repeatedly during the second stage of labor. Attached to a pair of assisting arms 12, 22 are grasping handles 26, 28 that allow the mother to exert a force that is communicated through a chain and sprocket mechanism 16 to an associated lifting arm 14, 24 and thigh pad 18, 20 which underlie the thighs, thereby raising her legs to the desired position for pushing.

In one representative embodiment, a mechanical advantage provided by the chain and sprocket mechanism 16 is such that a force that is applied to the thigh pads 18, 20 is about twice as large (e.g., a multiplier of 1.98-2.10) as the force exerted by the patient. For example, the sprocket associated with the assisting arms 12, 22 may have about one-half of the number of teeth (e.g., assisting:lifting=20:40) on the sprocket associated with the lifting arms. This enables the mother to achieve and maintain the desired position for pushing during a contraction. At the end of the contraction, the system allows the mother's legs to be returned to their resting position. Such a system assists the mother in expending less effort lifting her legs, thereby saving energy for pushing. If required, a caregiver can utilize the device to aid the laboring mother.

TABLE OF REFERENCE NUMBERS

| Reference | |
|---|---|
| No. | Component |
| 10 | Medical Procedure Facilitation System |
| 12 | Assisting (Driving) Arm |
| 14 | Lifting (Driven) Arm |
| 16 | Chain and Sprocket Subsystem (One per Side of Operating |
| | Platform) |
| 18 | Adjustable Thigh Support Pad |
| 20 | Adjustable Thigh Support Pad |
| 22 | Assisting (Driving) Arm |
| 24 | Lifting (Driven) Arm |
| 26 | Hand Grip |
| 28 | Hand Grip |
| 30 | Foundation Plate |
| 32 | Ratchet and Pawl Subsystem (One per Side of Operating |
| | Platform) |
| 34 | Ratchet and Pawl Subsystem (One per Side of Operating |
| | Platform) |
| 36 | Mounting Plate |
| 38 | Bolt |
| 40 | Slot |
| 42 | Stud |
| 44 | Pawl |
| 46 | Ratchet |
| 48 | Rod |
| 50 | Chain or belt |
| 52 | Spring |
| 54 | Assisting arm sprocket |
| 56 | Lifting arm sprocket |

While exemplary embodiments are described above, it is not intended that these embodiments describe all possible forms of the disclosed medical procedure facilitation system. Rather, the words used in the specification are words of description rather than limitation, and it is understood that various changes may be made without departing from the spirit and scope of the invention. Additionally, the features of various implementing embodiments may be combined to form further embodiments of the invention.

We claim:

1. A medical procedure facilitation system for use with an operating platform upon which the patient is recumbent, semi-recumbent, or in a semi-Fowler's position, the operating platform having lateral edges, the medical procedure facilitation system comprising:
a pair of assisting arms secured to the lateral edges, the pair of assisting arms being adapted to move in a path of rotation, the pair of assisting arms enabling the patient to exert a force that assists in supporting the patient's thighs;
a pair of lifting arms secured to the lateral edges that are also adapted to move in a path of rotation, the pair of lifting arms having supportive pad sub-assemblies extending therefrom that offer support under the thighs of the patient;
a chain and sprocket mechanism in communication with a lower end region of one of the pairs of assisting arms and a lower end region of one of the pairs of lifting arms for transmitting a patient-delivered force that assists in raising and securing one or more positions of the patient's legs; and
handgrips mounted on the assisting arms that allow the patient to apply the patient-delivered force and position the pad sub-assemblies.

2. The medical procedure facilitation system of claim 1, further including a ratchet and pawl mechanism associated with a lower end region of each of the pair of assisting arms, the ratchet and pawl mechanism being adapted to influence radial positioning of the assisting arms in their respective paths of rotation about the lower end regions of the assisting arms.

3. The medical procedure facilitation system of claim 1, wherein the supportive pad sub-assemblies include an adjusting mechanism so that an angle of inclination of the pad sub-assemblies may be adjusted to accommodate the size and position of the patient.

4. The medical procedure facilitation system of claim 2, wherein the ratchet and pawl mechanism includes a ratchet that is mounted on an axle located at a lower end region of an associated assisting arm.

5. The medical procedure facilitation system of claim 1, further including the operating platform to which the medical procedure facilitation system is secured.

6. The medical procedure facilitation system of claim 1, wherein the chain and sprocket mechanism includes an assisting arm sprocket, a lifting arm sprocket having a larger diameter than the assisting arm sprocket, and a chain extending between the assisting arm sprocket and the lifting arm sprocket.

7. The medical procedure facilitation system of claim 1, wherein the hand grips are mounted at an upper-end region of the pair of assisting arms.

8. The medical procedure facilitation system of claim 7, wherein the chain and sprocket mechanism transmits a force that helps lift or position one or more legs of the patient, the hand grips allowing the patient to determine an intermediate resting position.

9. The medical procedure facilitation system of claim 2, wherein the ratchet and pawl mechanism includes a locking feature that allows the medical staff or the patient to lock the system in place at any position so that the patient can have her or his legs supported completely or almost completely by the system.

10. The medical procedure facilitation system of claim 1, wherein each arm in the pair of assisting arms is adapted to move independently of the other arm in the pair.

11. The medical procedure facilitation system of claim 1, further including a mounting plate secured to the operating platform to which lower end regions of the assisting and lifting arms are attached, the mounting plate cooperating with the operating platform to secure the medical procedure facilitation system.

12. The medical procedure facilitation system of claim 11, wherein the mounting plate is adapted to rotate in a vertical plane about a bolt that secures the mounting plate to the operating platform, the mounting plate including a slot that receives a stud attached to the operating platform so that rotational movement of the mounting plate is restricted.

13. The medical procedure facilitation system of claim 1, wherein lower end regions of the assisting arms and/or the lifting arms are positionable along the lateral edges of the bed to accommodate patients of various sizes.

14. A medical procedure facilitation system for use with an operating platform upon which the patient is recumbent, semi-recumbent, or in a semi-Fowler's position, the operating platform having lateral edges, the medical procedure facilitation system comprising:
a pair of assisting arms secured to the lateral edges, the pair of assisting arms being adapted to move in a path of rotation, the pair of assisting arms enabling the patient to exert a force that assists in supporting the patient's thighs;
a pair of lifting arms secured to the lateral edges that are also adapted to move along a path of rotation, the pair of lifting arms having supportive pad sub-assemblies that offer support under the thighs of the patient;
a drive mechanism in communication with a lower end region of one of the pairs of assisting arms and a lower end region of one of the pairs of lifting arms for transmitting a patient-supplied force that assists in raising and securing one or more positions of the patient's legs; and
handgrips mounted on the assisting arms that allow the patient to apply assisting forces and position the pad sub-assemblies.

15. A method of assisting a patient who is recumbent, semi-recumbent, or in a semi-Fowler's position on an operating platform having lateral edges, the patient being subjected to a medical procedure that involves flexion, external rotation, and/or abduction of the lower extremity, the method comprising the steps of, not necessarily on the order presented:
securing a pair of assisting arms to the lateral edges of the operating platform, the pair of assisting arms being adapted to move along a path of rotation;
attaching a pair of lifting arms to the lateral sides of the bed for providing a force that raises and/or supports one or more positions of the patient's legs; and
providing a chain and sprocket mechanism that communicates a force applied by the patient through the assisting arms to the lifting arms and pad sub-assemblies extending therefrom, the pad sub-assemblies offering support under the thighs of the patient.
